(19) United States
(12) Patent Application Publication
(10) Pub. No.: US 2016/0316787 A1
(43) Pub. Date: Nov. 3, 2016

(54) ANTLER PET CHEWS AND METHODS OF MANUFACTURE

(71) Applicant: HIMALAYAN CORPORATION, Mukilteo, WA (US)

(72) Inventor: Suman K. SHRESTHA, Marysville, WA (US)

(21) Appl. No.: 14/701,167

(22) Filed: Apr. 30, 2015

(51) Int. Cl. A23K 1/10; A23K 1/18

(52) U.S. Cl. CPC A23K 1/106; A23K 1/1846

(57) ABSTRACT

Antler pet chew products and methods of manufacturing such products are disclosed. Some antler pet chew products may comprise an antler section length defined by a distance between proximal and distal ends and antler section sides extending between the proximal and distal ends. At least one antler section side may comprise a natural antler exterior, while one or more other antler section sides may comprise an exposed antler interior. A layer of dried, hardened bonding substance, such as a cheese formulated to bond with antler, may be bonded to the antler section sides comprising the exposed antler interior. One or more cavities may be drilled in the antler section and the dried, hardened bonding substance may be bonded to cavity sidewalls.

### BACKGROUND

There are a variety of popular pet chew products available in pet supply stores, such as bones, ropes, rawhides, bully sticks, rubber chew toys, and hardened cheeses. Himalayan Dog Chews, imported from Nepal and distributed in the United States by the Himalayan Corporation, are one example of hardened cheese pet chews generally made of yak or cow milk. There is an ongoing need to increase the variety of pet chew products to meet the needs and preferences available to dog and other pet owners.

### SUMMARY

Antler pet chew products and methods of manufacturing such products are disclosed. Some example antler pet chew products may comprise an antler section having a proximal end, a distal end, and an antler section length defined by a distance between the proximal and distal ends. Antler section sides may extend between the proximal and distal ends. At least one antler section side may comprise a natural antler exterior, while one or more other antler section sides may comprise an exposed antler interior. A layer of dried, hardened bonding substance, such as a cheese formulated to bond with antler, may be bonded to the antler section sides comprising the exposed antler interior.

Some example methods of manufacturing an antler pet chew product may include forming an antler section, e.g., by cutting an antler crosswise to form a proximal end, a distal end, and an antler section length defined by a distance between the proximal and distal ends; and cutting the antler lengthwise to form a plurality of antler section sides extending between the proximal and distal ends. At least one antler section side may comprise a natural antler exterior, while one or more other antler section sides may comprise exposed antler interior, exposed by the lengthwise cutting. A bonding substance such as a formulated cheese may be heated, and a layer of the heated bonding substance may be applied to the antler section sides comprising the exposed antler interior. The antler section may be cooled to produce a layer of dried, hardened cheese or other bonding substance, bonded to the antler section sides comprising the exposed antler interior.

In some embodiments, antler pet chew products may comprise an antler section having a proximal end, a distal end, and an antler section length defined by a distance between the proximal and distal ends. A cavity may be formed in the antler section. The cavity may comprise, e.g., a cavity opening at the proximal end and a cavity sidewall extending into the antler section toward the distal end. A dried, hardened bonding substance, such as a formulated cheese, may be deposited in the cavity and bonded to the cavity sidewall.

Some example methods of manufacturing an antler pet chew product may include forming an antler section, e.g., by cutting an antler crosswise to form a proximal end, a distal end, and an antler section length defined by a distance between the proximal and distal ends; and drilling a cavity in the antler section. The cavity may comprise, e.g., a cavity opening at the proximal end and a cavity sidewall extending into the antler section toward the distal end. A bonding substance, such as a formulated cheese, may be heated and deposited in the cavity. The antler section may be cooled to produce the antler pet chew product comprising dried, hardened bonding substance deposited in the cavity and bonded to the cavity sidewall. Additional aspects of this disclosure are described in further detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 illustrates an example antler pet chew product comprising an antler section with antler section sides extending between proximal and distal ends, and a layer of dried, hardened bonding substance bonded to the antler section sides.

FIG. 2 illustrates another example antler pet chew product comprising an antler section with antler section sides extending between proximal and distal ends, and a layer of dried, hardened bonding substance bonded to the antler section sides. A

FIG. 3 illustrates an example antler pet chew product comprising an antler section with a cavity formed therein and a dried, hardened bonding substance deposited in the cavity and bonded to the cavity sidewall.

FIG. 4 illustrates an example method of manufacturing an antler pet chew product, the antler pet chew product comprising a layer of dried, hardened bonding substance bonded to antler section sides.

FIG. 5 illustrates an example method of manufacturing an antler pet chew product, the antler pet chew product comprising a dried, hardened bonding substance deposited in a cavity and bonded to the cavity sidewall.

### DETAILED DESCRIPTION

Prior to explaining embodiments of the invention in detail, it is to be understood that this disclosure is not limited to the details of construction or arrangements of the components and method steps set forth in the following description or illustrated in the drawings. Embodiments of this disclosure are capable of other embodiments and of being practiced and carried out in various ways. Also, it is to be understood that the phraseology and terminology employed herein are for the purpose of the description and should not be regarded as limiting.

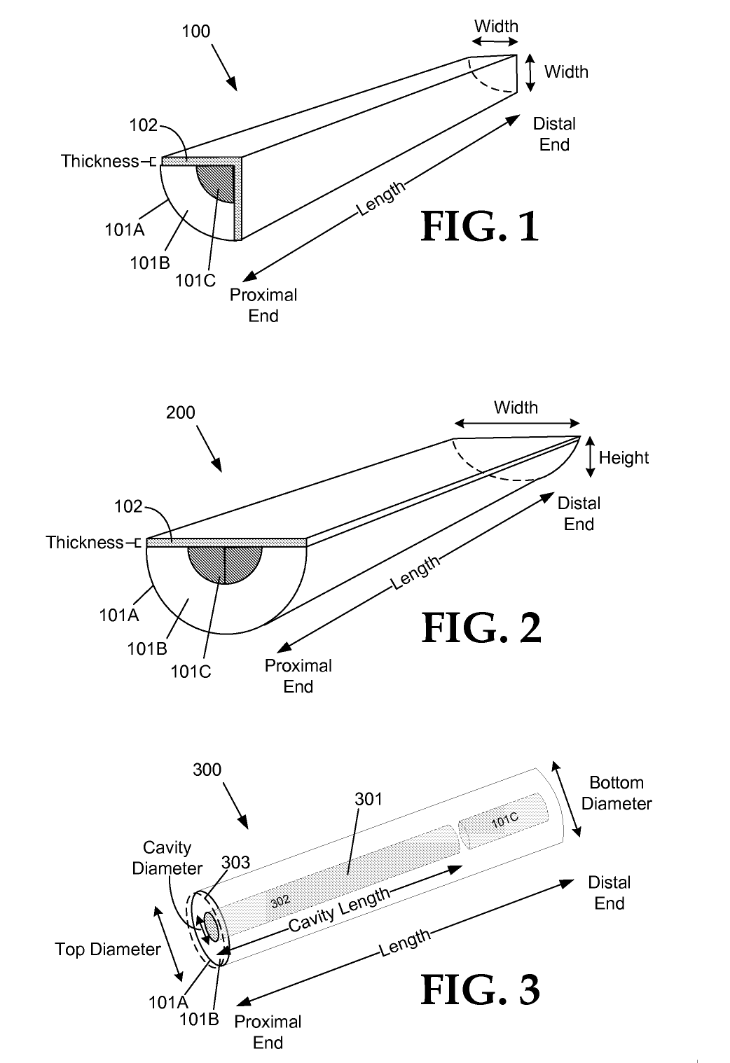

FIG. 1 illustrates an example antler pet chew product comprising an antler section with antler section sides extending between proximal and distal ends, and a layer of dried, hardened bonding substance bonded to the antler section sides. Antler pet chew product 100 includes an antler section having a proximal end, a distal end, and an antler section length defined by a distance between the proximal and distal ends. The antler section is composed of a natural antler exterior portion 101A, a bony antler interior portion 101B, and a marrow antler interior portion 101C. The antler section may be made from any type of antler, including but not limited to deer, reindeer, elk, or otherwise. In some embodiments, the antler section may optionally be made from any animal bone. In some embodiments, the antler section may optionally be made from horn, e.g., goat, bull, bison, or yak horn.

In FIG. 1, a plurality of antler section sides extend between the proximal and distal ends of the illustrated antler section. The embodiment of FIG. 1 consists of three antler section sides. One antler section side is a curved side comprising the natural antler exterior portion 101A. The other two antler section sides comprise exposed antler interior which is bonded to a layer of dried, hardened bonding substance 102.

In FIG. 1, each of the two antler section sides comprising exposed antler interior are substantially planar, and the two antler section sides comprising the exposed antler interior meet at a substantially right angle. The antler section sides comprising exposed antler interior may be formed, e.g., by cutting the antler lengthwise from the proximal end to the distal end. The antler section sides comprising exposed antler interior may be composed of portions including exposed bony antler interior 101B as well as portions including exposed marrow antler interior 101C.

FIG. 2 illustrates another example antler pet chew product comprising an antler section with antler section sides extending between proximal and distal ends, and a layer of dried, hardened bonding substance bonded to the antler section sides. Like the antler pet chew product 100, antler pet chew product 200 includes an antler section having a proximal end, a distal end, and an antler section length defined by a distance between the proximal and distal ends. The antler section in FIG. 2 is composed of a natural antler exterior portion 101A, a bony antler interior portion 101B, and a marrow antler interior portion 101C. A plurality of antler section sides extend between the proximal and distal ends of the antler section.

The embodiment of FIG. 2 includes two antler section sides. One antler section side is a curved side comprising the natural antler exterior portion 101A. The other antler section side comprises exposed antler interior which is bonded to a layer of dried, hardened bonding substance 102. The antler section side comprising exposed antler interior is substantially planar. The antler section side comprising exposed antler interior may be formed, e.g., by cutting the antler lengthwise from the proximal end to the distal end. The antler section side comprising exposed antler interior may be composed of portions including exposed bony antler interior 101B as well as a portion including exposed marrow antler interior 101C.

With reference to FIGS. 1 and 2, it will be understood that in alternative embodiments, antler sections may be formed so as to have any number of antler section sides, which may meet at any angle(s), and which may optionally be separated by antler section sides comprising natural antler exterior 101A. Antler section sides may be planar or otherwise, e.g., antler section sides may be curved, bumpy, or composed of multiple planar surfaces meeting at various angles. Antler section sides may extend the full length of the antler section, from the proximal end to the distal end, or may extend only a portion of such length, e.g., when cut short by one or more other antler section sides. Depending on how the antler section is formed, antler section sides comprising exposed antler interior may include both exposed bony antler interior 101B as well as exposed marrow antler interior 101C, as illustrated in FIGS. 1 and 2, or may include only exposed bony antler interior 101B, or only exposed marrow antler interior 101C.

Antler pet chew products 100 and 200 may have any desired dimensions. In general, preferred antler section lengths for products 100 and 200 may be from 10-30 centimeters, or from 15-25 centimeters, however, embodiments may include shorter or longer lengths. In embodiments according to FIG. 1, each of the two antler section sides comprising exposed antler interior may be from 1.25 to 4 centimeters in width. In embodiments according to FIG. 2, the antler section side comprising exposed antler interior may be from 2-7 centimeters in width.

The dried, hardened bonding substance 102 may comprise any non-toxic substance capable of forming a bond with exposed bony antler interior 101B and exposed marrow antler interior 101C. Dried, hardened bonding substance 102 may comprise, e.g., a dried, hardened cheese. In some embodiments, a cheese may be formulated by combining skim milk, salt, and lime juice, and processing the combination into a cheese. Additional and/or alternative ingredients may be added or substituted to impart desired flavor, color, and/or bonding properties, or to impart properties desired for manufacture of antler pet chew products 100 and 200, such as desired melt temperature, specific heat, stickiness, or other manufacturing related properties.

In some embodiments, layers of dried, hardened bonding substance 102 such as illustrated in FIGS. 1 and 2 may have a thickness from about 0.5-3 millimeters, although thinner or thicker layers may also be applied. Also, layers of dried, hardened bonding substance 102 may cover substantially all of the antler section sides comprising exposed antler interior, as illustrated in FIGS. 1 and 2. Alternatively, layers of dried, hardened bonding substance 102 may cover limited portions of the antler section sides comprising exposed antler interior. For example, dried, hardened bonding substance 102 may be applied only to exposed bony antler interior 101B, or only to exposed marrow antler interior 101C. In another example, dried, hardened bonding substance 102 may be applied in a repeating pattern, or to form one or more letters, or to form a line-art picture. In some embodiments, grooves may be cut into antler section sides, or antler section sides may be otherwise textured, and the bonding substance 102 may be applied inside the grooves or other texture elements. In some embodiments, hardened bonding substance 102 may be applied to antler section sides comprising natural antler exterior 101A, e.g., within naturally occurring grooves in the natural antler exterior 101A. In some embodiments, hardened bonding substance 102 may be applied to the proximal and/or distal ends of antler sections, in addition to the antler section sides.

FIG. 3 illustrates an example antler pet chew product comprising an antler section with a cavity formed therein and a dried, hardened bonding substance deposited in the cavity and bonded to the cavity sidewall. Like the antler pet chew products 100 and 200, antler pet chew product 300 includes an antler section having a proximal end, a distal end, and an antler section length defined by a distance between the proximal and distal ends. The antler section in FIG. 3 is composed of a natural antler exterior portion 101A, a bony antler interior portion 101B, and a marrow antler interior portion 101C.

In FIG. 3, a cavity 301 is formed in the illustrated antler section, wherein the cavity 301 comprises a cavity opening at the proximal end and a cylindrical cavity sidewall extending into the antler section and toward the distal end. A dried, hardened bonding substance 302 is deposited in the cavity 301, and the dried, hardened bonding substance 302 is bonded to the cavity sidewall.

In some embodiments according to FIG. 3, substantially all of the exterior surface of the antler section, extending between the proximal end and the distal end, may comprise natural antler exterior 101A. Alternatively, one or more additional antler section sides may be formed, and embodiments according to FIG. 3 may thereby be combined with any aspects according to FIG. 1 or 2, as may be desired. The length of antler pet chew product 300 may be from 10-30 centimeters. The antler section may have a top diameter at the proximal end and a bottom diameter at the distal end. The top and bottom diameters may be from 0.5-5 centimeters. In some embodiments, the antler section illustrated in FIG. 3 may taper from a wide top diameter, from 2 to 5 centimeters wide at the proximal end, to a narrow bottom diameter, from 0.5 to 2.5 centimeters wide at the distal end.

In some embodiments, the cavity opening may be substantially centered in the proximal end, and the cavity 301 may have a cavity diameter that is substantially equal to a diameter of the marrow antler interior 101C, as illustrated in FIG. 3. Alternatively, cavity 301 may have a cavity diameter from 0.5-2 centimeters. The cavity 301 may have a cavity length less than the antler section length and which extends any desired distance, e.g., cavity length may be in the range of one tenth ( 1/10) to two-thirds (⅔) of the antler section length. In some embodiments, the cavity 301 may have a cavity length equal to the antler section length, that is, the cavity 301 may extend entirely through the antler section.

In some embodiments, multiple cavities may be formed inside the antler section. Any cavity may have a wider or narrower cavity diameter than illustrated in FIG. 3. Any cavity may have a cavity opening located anywhere on the antler section, e.g., a cavity opening at an antler section side or distal end, and such cavities may replace or supplement cavity 301 with its opening at the proximal end. Also, any cavity may extend in any desired direction into the antler section. For example, in some embodiments, a second cavity with cavity opening at the distal end may extend from the distal end into the antler section towards the proximal end. In some embodiments, one or more additional cavities, in addition to cavity 301, with cavity openings along the antler section side may extend from the antler section side into the antler section, optionally intersecting cavity 301.

A dried, hardened bonding substance 302, such as a dried, hardened cheese, may be deposited in the cavity 301 and bonded to the cavity sidewall. In some embodiments, the bonding substance 302 may substantially fill the cavity 301. In some embodiments, the bonding substance 302 may extend beyond the cavity opening to form a layer, illustrated by the dotted ellipse at the proximal end of antler pet chew product 300, which is bonded with a lip of the antler section at the proximal end. The layer bonded with the lip may have a thickness from about 0.5-3 millimeters.

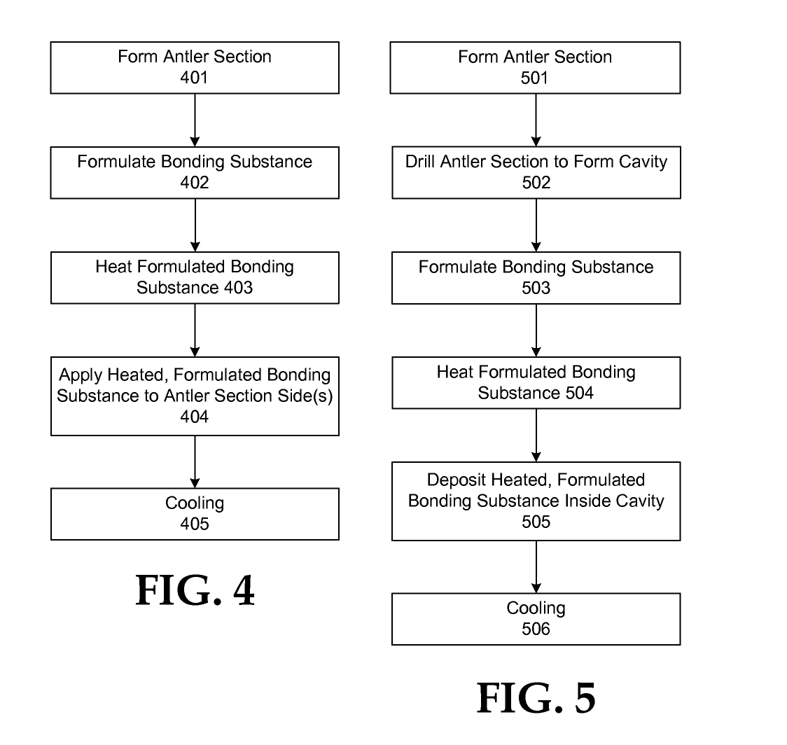

FIG. 4 illustrates an example method of manufacturing an antler pet chew product, the antler pet chew product comprising a layer of dried, hardened bonding substance bonded to antler section sides. Methods according to FIG. 4 may be used, for example, to manufacture antler pet chew products such as illustrated in FIGS. 1 and 2. FIG. 4 includes a “Form Antler Section” block 401, a “Formulate Bonding Substance” block 402, a “Heat Formulated Bonding Substance” block 403, an “Apply Heated, Formulated Bonding Substance to Antler Section Side(s)” block 404, and a “Cooling” block 405.

At “Form Antler Section” block 401, an antler may be selected and may be cut to a desired shape and size to form the antler section. The antler section formed at block 401 may comprise any of the structures disclosed herein, e.g., an antler section according to FIG. 1 or 2 and optionally including aspects of FIG. 3, and the antler section may have antler section dimensions described herein.

The antler may be cut crosswise at block 401, e.g., with a saw or other cutting tool, to form a proximal end, a distal end, and an antler section length defined by a distance between the proximal end and the distal end. Two crosswise cuts may be used, one to form the proximal end and one to form the distal end. In some embodiments, the antler may be broken instead of cut to form the proximal end and/or the distal end. In some embodiments, a naturally occurring end, such as the base or tip of an antler, may be used for the proximal end and/or the distal end.

The antler may also be cut lengthwise at block 401, e.g., with a saw, grinder, or other cutting tool, to form one or more antler section sides extending between the proximal end and the distal end. The one or more antler section sides formed by the lengthwise cutting may comprise exposed antler interior, which is exposed by the lengthwise cutting. The word “cut” is defined herein to include cutting as well as grinding. Antler section sides that are left uncut may retain their natural antler exterior, extending between the proximal end and the distal end or otherwise extending through some portion of the antler section length.

In some embodiments, block 401 may consist of two crosswise cuts, one to form the proximal end and one to form the distal end, and two lengthwise cuts. The two lengthwise cuts may each form one antler section side comprising exposed antler interior, wherein each of the two antler section sides formed thereby are substantially planar, include at least one bony antler interior portion and at least on marrow antler interior portion, and meet at a substantially right angle. Such a process may include cutting an antler lengthwise into four quarter sections, such as illustrated in FIG. 1. In other embodiments, additional or fewer lengthwise cuts may be applied to form additional or fewer antler section sides comprising exposed antler interior.

At “Formulate Bonding Substance” block 402, a cheese or other bonding substance may be formulated. Appropriate bonding substances may be adapted to be applicable to antler surfaces, e.g., at block 404, and to form a strong bond with antler, e.g., after cooling at block 405. Appropriate bonding substances may, when dried, form a hard crust bonded to antler surfaces. Appropriate bonding substances may optionally furthermore have flavor and/or protein or other nutrient content that is satisfying to dogs or other chewing pets.

In some embodiments, the bonding substance may comprise a cheese formulated by combining skim milk, salt, and lime juice. For example, milk may be coagulated into cheese by treating with lime juice and salt. Coagulated cheese may be packed in burlap sacks which may be used as cheese cloth. This packed cheese may then be pressed for about several days to remove the moisture. After about 6-7 days, the burlap may be unwrapped and the cheese block may be taken out. This block may be cut into pieces which may range anywhere from about 0.5 inches to about 3.0 inches thick and about 2 inches to about 24 inches long. The cut rectangular pieces may then be sun dried and/or smoked for a period of time from weeks to months, to form a hardened cheese appropriate for dog and other pet consumption.

At “Heat Formulated Bonding Substance” block 403, the bonding substance formulated at block 402 may be heated until soft. For example, cheeses formulated according to this disclosure may be heated to within the range of about 30-90 degrees Celsius, depending on the type of cheese. Other bonding substances may be heated to other temperature ranges as appropriate. Some bonding substances, such as non-toxic glues or other substances, may not require heating.

At “Apply Heated, Formulated Bonding Substance to Antler Section Side(s)” block 404, the bonding substance formulated at block 402 and optionally heated at block 403 may be applied to antler section sides. For example, the bonding substance may be spread, squeezed, mashed, pressed, brushed, or otherwise brought into contact with one or more antler section sides comprising exposed antler interior. The bonding substance may be applied, for example, in a layer having a thickness from about 0.5-3 millimeters, and optionally covering substantially all of the antler section sides comprising exposed antler interior. Alternatively, the bonding substance may be applied in a pattern, only to bony antler interior, or otherwise to produce the structures described herein. The bonding substance may also optionally also be applied to antler section sides comprising natural antler exterior.

At “Cooling” block 405, the antler section and the heated cheese or other bonding substance may be cooled to produce a layer of dried, hardened bonding substance bonded to one or more of the antler section sides comprising exposed antler interior. In some embodiments, antler sections may be placed in a dry, cool environment to cool. In some embodiments, antler sections may be irradiated, e.g., by sunlight or overhead lights, or placed under a blower to generate an airflow across the antler sections to promote drying and cooling. In some embodiments, antler sections may be placed outdoors or indoors at room temperature in order to dry and cool.

FIG. 5 illustrates an example method of manufacturing an antler pet chew product, the antler pet chew product comprising a dried, hardened bonding substance deposited in a cavity and bonded to the cavity sidewall. Methods according to FIG. 5 may be used, for example, to manufacture antler pet chew products such as illustrated in FIG. 3. FIG. 5 includes a “Form Antler Section” block 501, a “Drill Antler Section to Form Cavity” block 502, a “Formulate Bonding Substance” block 503, a “Heat Formulated Bonding Substance” block 504, a “Deposit Heated, Formulated Bonding Substance Inside Cavity” block 505, and a “Cooling” block 506.

At “Form Antler Section” block 501, an antler may be selected and may be cut to a desired shape and size, and one or more cavities may be drilled therein, to form the antler section. The antler section formed at block 501 may comprise any of the structures disclosed herein, e.g., an antler section according to FIG. 3 and optionally including aspects of FIGS. 1 and 2, and the antler section may have antler section dimensions described herein.

The antler may be cut crosswise at block 501, e.g., with a saw or other cutting tool, to form a proximal end, a distal end, and an antler section length defined by a distance between the proximal end and the distal end, as described above in connection with block 401. Antler section sides may optionally be left uncut in order to retain their natural antler exterior, extending between the proximal end and the distal end of the antler section. Otherwise, antler section sides may optionally be cut lengthwise as described above at block 401, to form one or more antler section sides comprising exposed antler interior, and thereby combining features of FIGS. 1 and 2 with FIG. 3. In some embodiments, the antler section may taper from a wide top diameter at the proximal end to a narrow bottom diameter at the distal end.

At “Drill Antler Section to Form Cavity” block 502, the antler may be drilled to form one or more cavities therein, such as example cavity 301 illustrated in FIG. 3. In some embodiments, the drilled cavity may comprise a cavity opening at the proximal end of the antler section and a cavity sidewall extending into the antler section toward the proximal end. In some embodiments, the cavity may be drilled to a cavity length less than the antler section length. The cavity may generally include any of the features described herein with reference to FIG. 3. It will be appreciated that in some embodiments, block 502 may be considered to be a part of “Form Antler Section” block 501.

At “Formulate Bonding Substance” block 503, a cheese or other bonding substance may be formulated as described above in connection with block 402. At “Heat Formulated Bonding Substance” block 504, the bonding substance formulated at block 503 may be heated as described above in connection with block 403.

At “Deposit Heated, Formulated Bonding Substance to Inside Antler Cavity” block 505, the bonding substance formulated at block 503 and optionally heated at block 504 may be deposited inside cavities drilled at block 502. For example, the bonding substance may be squeezed, packed, pressed, dripped, poured, brushed, or otherwise deposited inside cavities drilled at block 502. The bonding substance may be deposited, for example, by substantially filling the cavity, or by applying a layer of the bonding substance to cavity sidewalls. In some embodiments, the bonding substance may overfill the cavity and thereby extend beyond the cavity opening to form a layer bonded with a lip of the antler section surrounding the cavity opening, e.g., a lip at the proximal end. The layer may have, e.g., a thickness from about 0.5-3 millimeters, and may optionally cover substantially all of the proximal end of the antler section.

At “Cooling” block 506, the antler section and the heated cheese or other bonding substance deposited in cavities thereof may be cooled to produce an antler pet chew product, such as 300, comprising dried, hardened cheese deposited in a cavity and bonded to a cavity sidewall. Cooling block 506 may be performed as described above in connection with block 405.

While various embodiments have been disclosed herein, other aspects and embodiments will be apparent to those skilled in art.

1. An antler pet chew product, comprising:
an antler section having a proximal end, a distal end, an antler section length defined by a distance between said proximal end and said distal end, and a plurality of antler section sides extending between said proximal end and said distal end;
wherein at least one antler section side extending between said proximal end and said distal end comprises a natural antler exterior;
wherein one or more other antler section sides extending between said proximal end and said distal end comprise exposed antler interior; and
a layer of dried, hardened cheese bonded to at least one of the antler section sides comprising exposed antler interior.

2. The antler pet chew product of claim 1, wherein the plurality of antler section sides extending between said proximal end and said distal end consist of three antler section sides, including:
one antler section side comprising the natural antler exterior; and
two antler section sides comprising exposed antler interior, wherein:
each of the two antler section sides comprising exposed antler interior are substantially planar;
each of the two antler section sides comprising exposed antler interior include at least one bony antler interior portion and at least one marrow antler interior portion; and
the two antler section sides comprising the exposed antler interior meet at a substantially right angle.

3. The antler pet chew product of claim 2, wherein each of the two antler section sides comprising exposed antler interior are between 1.25 centimeters to 4 centimeters in width.

4. The antler pet chew product of claim 1, wherein the antler section length is from about 10-30 centimeters.

5. The antler pet chew product of claim 1, wherein the layer of dried, hardened cheese has a thickness from about 0.5-3 millimeters, and wherein the layer of dried, hardened cheese covers substantially all of the antler section sides comprising exposed antler interior.

6. The antler pet chew product of claim 1, wherein the dried, hardened cheese comprises a formulated combination of skim milk, salt, and lime juice.

7. A method of manufacturing an antler pet chew product, comprising:
forming an antler section, comprising:
cutting an antler crosswise to form a proximal end, a distal end, and an antler section length defined by a distance between said proximal end and said distal end; and
cutting the antler lengthwise to form a plurality of antler section sides extending between said proximal end and said distal end, wherein at least one antler section side extending between said proximal end and said distal end comprises a natural antler exterior, and wherein one or more other antler section sides extending between said proximal end and said distal end comprise exposed antler interior exposed by said cutting the antler lengthwise;
heating a cheese to produce a heated cheese;
applying a layer of the heated cheese to at least one of the antler section sides comprising exposed antler interior; and
cooling the antler section and the heated cheese to produce a layer of dried, hardened cheese bonded to the at least one of the antler section sides comprising the exposed antler interior.

8. The method of manufacturing an antler pet chew product of claim 7, wherein the plurality of antler section sides formed by said cutting the antler lengthwise and extending between said proximal end and said distal end consist of three antler section sides, including:
one antler section side comprising the natural antler exterior; and
two antler section sides comprising exposed antler interior, wherein:
each of the two antler section sides comprising exposed antler interior are substantially planar;
each of the two antler section sides comprising exposed antler interior include at least one bony antler interior portion and at least on marrow antler interior portion; and
the two antler section sides comprising exposed antler interior meet at a substantially right angle.

9. The method of manufacturing an antler pet chew product of claim 8, wherein each of the two antler section sides formed by said cutting the antler lengthwise and comprising exposed antler interior are from about 1.25-4 centimeters in width.

10. The method of manufacturing an antler pet chew product of claim 7, wherein the antler section length formed by cutting the antler crosswise is from about 10-30 centimeters.

11. The method of manufacturing an antler pet chew product of claim 7, wherein applying the layer of the heated cheese comprises applying the heated cheese at a thickness from about 0.5-3 millimeters, and covering substantially all of the at least one of the antler section sides comprising exposed antler interior.

12. The method of manufacturing an antler pet chew product of claim 7, further comprising formulating the cheese by combining skim milk, salt, and lime juice.

13. An antler pet chew product, comprising:
an antler section having a proximal end, a distal end, and an antler section length defined by a distance between said proximal end and said distal end;
a cavity formed in said antler section, wherein the cavity comprises a cavity opening at the proximal end and a cavity sidewall extending into the antler section and toward the distal end; and
dried, hardened cheese deposited in the cavity and bonded to the cavity sidewall.

14. The antler pet chew product of claim 13, wherein:
an exterior side surface of the antler section extending between said proximal end and said distal end comprises a natural antler exterior;
the antler section tapers from a wide top diameter at the proximal end to a narrow bottom diameter at the distal end;
the cavity comprises a cavity length less than the antler section length;
the dried, hardened cheese deposited in the cavity and bonded to the cavity sidewall substantially fills the cavity and extends beyond the cavity opening to form a layer bonded with a lip of the antler section at the proximal end.

15. The antler pet chew product of claim 13, wherein the antler section length is from about 10-30 centimeters, and wherein the antler section tapers from a wide top diameter, from about 2-5 centimeters wide at the proximal end, to a narrow bottom diameter, from about 0.5-2.5 centimeters wide at the distal end.

16. The antler pet chew product of claim 13, wherein the dried, hardened cheese deposited in the cavity and bonded to the cavity sidewall substantially fills the cavity and extends beyond the cavity opening to form a layer bonded with a lip of the antler section at the proximal end, and wherein the layer bonded with the lip has a thickness from about 0.5-3 millimeters.

17. The antler pet chew product of claim 13, wherein the dried, hardened cheese comprises a formulated combination of skim milk, salt, and lime juice.

18. A method of manufacturing an antler pet chew product, comprising:
forming an antler section, comprising:
cutting an antler crosswise to form a proximal end, a distal end, and an antler section length defined by a distance between said proximal end and said distal end; and
drilling a cavity in said antler section, wherein the cavity comprises a cavity opening at the proximal end and a cavity sidewall extending into the antler section and toward the proximal end;
heating a cheese to produce a heated cheese;
depositing the heated cheese in the cavity; and
cooling the antler section and the heated cheese to produce the antler pet chew product comprising dried, hardened cheese deposited in the cavity and bonded to the cavity sidewall.

19. The method of manufacturing an antler pet chew product of claim 18, wherein:
an exterior side surface of the antler section extending between said proximal end and said distal end comprises a natural antler exterior;
the antler section tapers from a wide top diameter at the proximal end to a narrow bottom diameter at the distal end;
the cavity is drilled to a cavity length less than the antler section length; and
the heated cheese is deposited in the cavity to substantially fill the cavity and to extend beyond the cavity opening to form a layer bonded with a lip of the antler section at the proximal end.

20. The method of manufacturing an antler pet chew product of claim 18, wherein the antler section length formed by cutting the antler crosswise is from about 10-30 centimeters, and wherein the antler section tapers from a wide top diameter, from about 2-5 centimeters wide at the proximal end, to a narrow bottom diameter, from about 0.5-2.5 centimeters wide at the distal end.

21. The method of manufacturing an antler pet chew product of claim 18, further comprising formulating the cheese by combining skim milk, salt, and lime juice.
